(19) United States
(12) Patent Application Publication
(10) Pub. No.: US 2008/0079555 A1
(43) Pub. Date: Apr. 3, 2008

(54) Vehicle emergency brake light control system

(76) Inventor: Hsu-Cheng Wang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/540,562

(22) Filed: Oct. 2, 2006

(51) Int. Cl. B60Q 1/44

(52) U.S. Cl. 340/479

(57) ABSTRACT

A vehicle emergency brake light control system includes a control box installed in a car and electrically connected to the ABS (Anti-lock braking system), a car battery power supply, a throttle valve, a brake light, a third brake light and an emergency brake light of the car such that when the driver of the motor vehicle suddenly steps on the brake pedal to drive on the ABS, the control box is induced by a signal from the ABS to drive the brake light, the third brake light and the emergency brake light to flash; when the ABS is released and the vehicle driver steps on the accelerator pedal of the car to move the car again, the throttle valve gives a signal to the control box, causing the control box to turn off the brake light, the third brake light and the emergency brake light.

### BACKGROUND OF THE INVENTION

1. Field of the Invention

The present invention relates to vehicle emergency brake lights and more specifically, to a vehicle emergency brake light control system, which automatically controls the brake light, third brake light, emergency brake light and car failure indicator light of the car to flash when the ABS (Anti-lock braking system) works.

2. Description of the Related Art

In downtown, cars are not moving on roads at a high speed. When a front car is stopped suddenly, the driver of the car right behind normally has sufficient time to stop the car, preventing a collision. Even a collision occurred at this time, the collision accident may not cause a hazard or potential injury. However, when in running on a highway or freeway where the road surface is wide, straight and smooth without intersection or traffic light, the driver can drive the car at a high speed for a long period. Under this monotonous situation, the driver may not aware of the high-speed condition, and may be less sensitive to variation of speed. Therefore, when a car accident happens on highway or freeway, it may cause a chain accident. A chain accident occurs due to high speed running of cars and slow reaction of braking action. When a chain accident occurs, it causes a hazard and severe injury. Further, a car generally has a third brake light to indicate the braking status. When the driver reduces the speed of the car or stops the car, the brake light and third brake light give the same braking indication. When the driver of a front car stepped on the brake to the extent to stop the car upon an accident, the brake light and the third brake light give the same usual braking signal that is insufficient to tell the driver of the car behind that the brake of the front car has been pressed to the extent and held down on the braking position, and the driver of the car behind may simply release the accelerator pedal and steps on the as usual but find the car still run into the rear side of the front car. Before the driver of the car behind finds the problem, and 2-3 seconds may have passed when the driver of the car behind steps on the brake to the extent. When running on a freeway, the speed of the car may be 60 miles or faster. Wasting this 2-3 seconds, the car may have moved over 50-70 meters. On a freeway, few cars keep the safety distance over 50 meters, and every car takes about 2-3 seconds before the brake pedal is pressed to the extent. If there are ten cars running one behind another at the same time, how long the safety distance is required in this condition? Therefore, when a chain accident occurs in a freeway, many behind cars ran into a front car even without pressing the brake pedal, and a car collision occurred in a freeway usually causes a relatively heavier hazard and more severe injury. If every car driver makes a reaction to brake the car 2 seconds earlier, a chain accident may be avoided.

Therefore, it is desirable to provide a vehicle emergency brake light control system that eliminates the aforesaid problems.

### SUMMARY OF THE INVENTION

The present invention has been accomplished under the circumstances in view. It is therefore the main object of the present invention to provide a vehicle emergency brake light control system, which accurately and positively provides a vehicle first sight warning effect upon a sudden stop. It is another object of the present invention to provide a vehicle emergency brake light control system, which greatly shortens the vehicle rear site brake reaction time, preventing a car collision.

To achieve these and other objects of the present invention, the vehicle emergency brake light control system comprises a control box installed in a motor vehicle, the motor vehicle comprising a ABS (Anti-lock braking system) electrically connected to the control box, a car battery power supply electrically connected to the control box through car fuse-box, a throttle valve electrically connected to the control box, a brake light electrically connected to the control box, a third brake light electrically connected to the control box, and an emergency brake light electrically connected to the control box, wherein when the driver of the motor vehicle suddenly steps on the brake pedal to drive on the ABS, the control box is induced by a signal from the ABS to output a control signal to the brake light, the third brake light and the emergency brake light, driving them to flash; wherein the ABS is released and the vehicle driver steps on the accelerator pedal of the motor vehicle to move the motor vehicle again, the throttle valve gives a signal to the control box, causing the control box to turn off the brake light, the third brake light and the emergency brake light.

### BRIEF DESCRIPTION OF THE DRAWINGS

FIG. 1 is a system block diagram according to the present invention.

FIG. 2 is a schematic drawing showing a vehicle embodying the present invention.

FIG. 3 is a system block diagram of an alternate form of the present invention.

### DETAILED DESCRIPTION OF THE PREFERRED EMBODIMENT

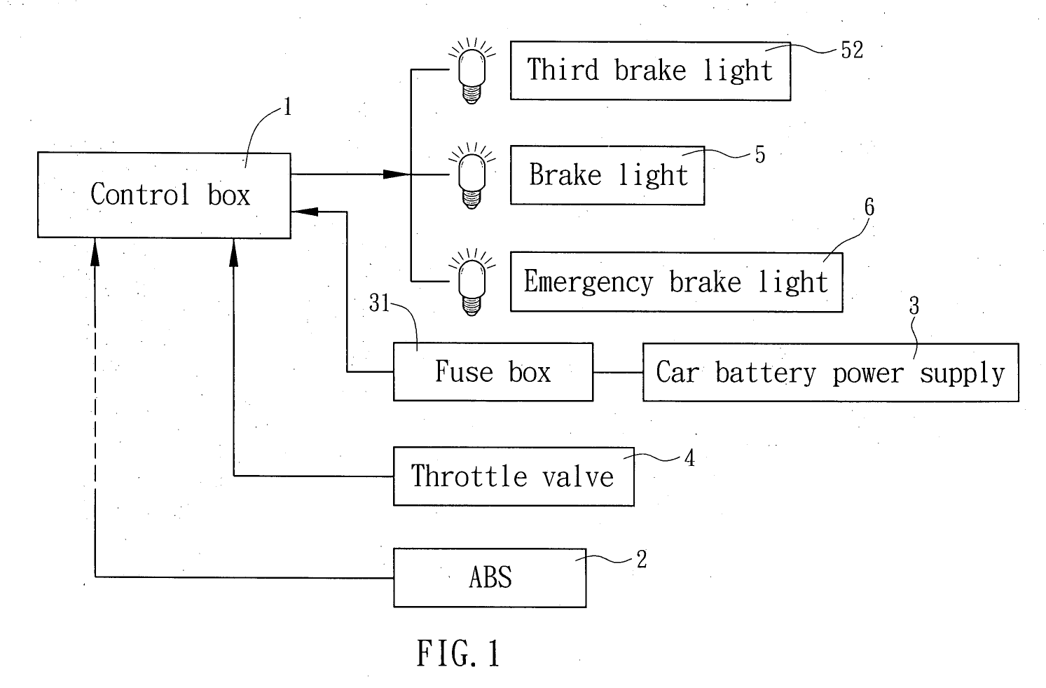

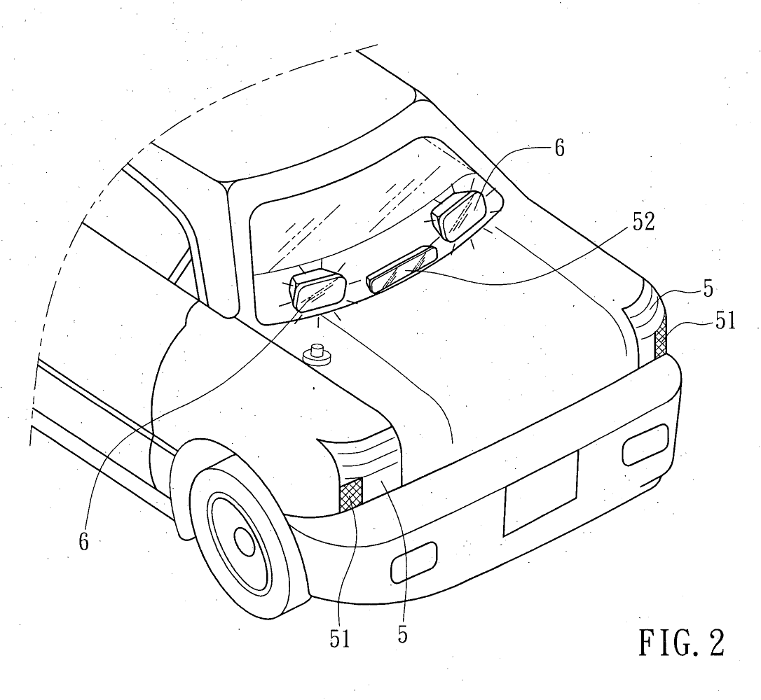

Referring to FIGS. 1 and 2, a vehicle emergency brake light control system in accordance with the present invention is shown comprising a control box 1 is shown installed in a motor vehicle, which has installed therein a ABS (Anti-lock braking system) 2, a car battery power supply 3 with a fuse-box 31, a throttle valve 4, a brake light 5, a third brake light 52, and an emergency brake light 6. The ABS (Anti-lock braking system) 2, the fuse-box 31 of the car battery power supply 3, the throttle valve 4, the brake light 5, the third brake light 52, and the emergency brake light 6 are respectively electrically connected to the control box 1. When the vehicle driver suddenly steps on the brake pedal to drive on the ABS 2, the control box 1 is induced by a signal from the ABS 2 to output a control signal to the brake light 5, the third brake light 52 and the emergency brake light 6, driving them to flash. When the emergency condition is eliminated and the ABS 2 is released and the vehicle driver steps on the accelerator pedal again, the throttle valve 4 gives a signal to the control box 1, causing the control box 1 to turn off the brake light 5, the third brake light 52 and the emergency brake light 6.

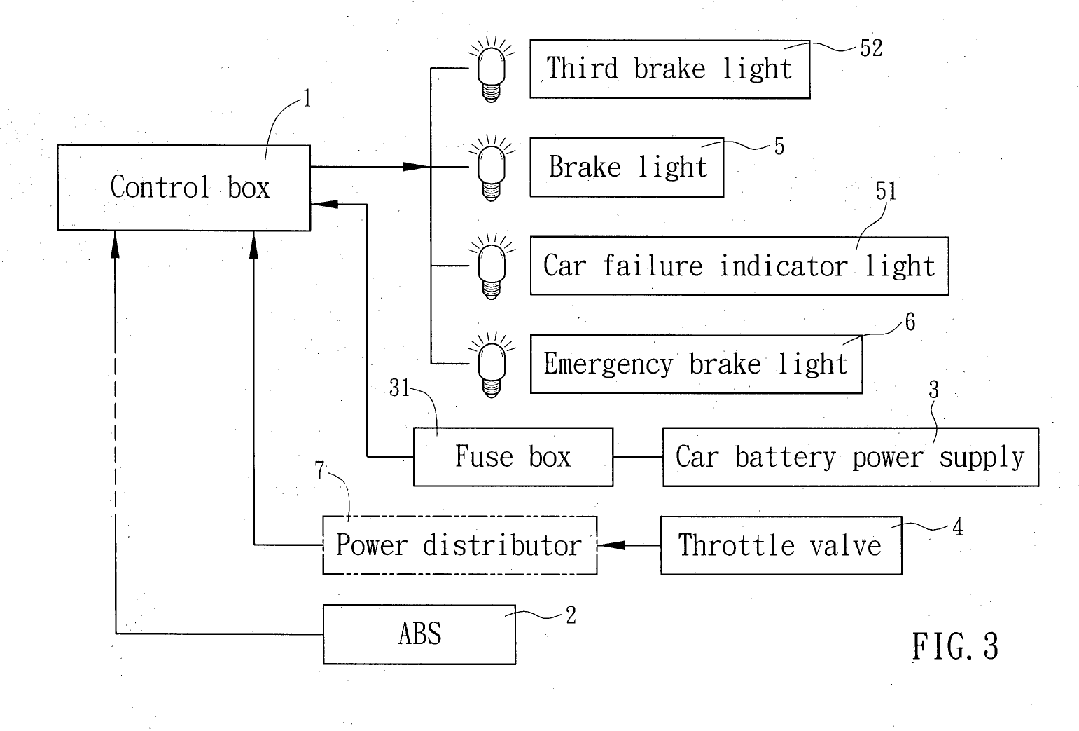

FIG. 3 is a system block diagram of an alternate form of the present invention. This embodiment is substantially similar to the aforesaid first embodiment with the exception of the additional car failure indicator light 51 and the exception that the throttle valve 4 is electrically connected to the control box 1 through the power distributor 7 of the vehicle.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A vehicle emergency brake light control system comprising a control box installed in a motor vehicle, said motor vehicle comprising a ABS (Anti-lock braking system) electrically connected to said control box, a car battery power supply electrically connected to said control box through a fuse-box, a throttle valve electrically connected to said control box, a brake light electrically connected to said control box, a third brake light electrically connected to said control box, and an emergency brake light electrically connected to said control box, wherein when the driver of the motor vehicle suddenly steps on the brake pedal to drive on said ABS, said control box is induced by a signal from said ABS to output a control signal to said brake light, said third brake light and said emergency brake light, driving them to flash; wherein said ABS is released and the vehicle driver steps on the accelerator pedal of the motor vehicle to move the motor vehicle again, said throttle valve gives a signal to said control box, causing said control box to turn off said brake light, said third brake light and said emergency brake light.

2. The vehicle emergency brake light control system as claimed in claim 1, wherein the motor vehicle further comprises a car failure indicator light electrically connected to said control box.

3. The vehicle emergency brake light control system as claimed in claim 1, wherein said throttle valve is electrically connected to said control box through a power distributor of the motor vehicle.
